(19) United States
(12) Patent Application Publication
(10) Pub. No.: US 2025/0077255 A1
(43) Pub. Date: Mar. 6, 2025

(54) Virtual Machine Firewall

(71) Applicant: Oracle International Corporation, Redwood Shores, CA (US)

(72) Inventors: Fahd ABIDI, Danville, CA (US); Timothy CLEGG, Custer, SD (US); Aparna RAMESH, Bellevue, WA (US)

(21) Appl. No.: 18/456,632

(22) Filed: Aug. 28, 2023

(51) Int. Cl. G06F 9/455

(52) U.S. Cl. CPC G06F 9/45558; G06F 2009/45587; G06F 2009/45591

(57) ABSTRACT

Embodiments are directed to a firewall for a virtual machine (“VM”) application. Embodiments initiate event monitoring of the VM application. Embodiments receive an event and compare the event to a plurality of events stored in a baseline profile of the VM application. When the event differs from any of the plurality of events, embodiments automatically generate an alert and/or perform an action corresponding to the VM application.

### FIELD

One embodiment is directed generally to a computer system, and in particular to a firewall for a computer system.

### BACKGROUND INFORMATION

A network firewall is a security device or software application that acts as a barrier between an internal computer network and external networks, such as the Internet, to monitor and control incoming and outgoing network traffic. Its primary function is to enforce a set of predefined security rules or policies to protect the network from unauthorized access, malicious activities, and potential threats.

In general, a firewall will look at activities and determine if they are acceptable (permitted) or forbidden (should be denied). Network firewalls work by examining the data packets that flow in and out of a network, based on various criteria such as source and destination IP addresses, port numbers, protocols, and packet contents. They apply a set of rules to determine whether to allow or block the packets. These rules can be configured to restrict access to specific ports, protocols, or Internet Protocol (“IP”) addresses, thereby controlling the flow of network traffic.

A network firewall, in general, functions by looking for patterns in network traffic, and matching the patterns with the patterns of previously known attacks. However, because predefined patterns need to be identified, network firewalls generally are inadequate against a zero-day attack, which refers to a cyber attack that exploits a vulnerability in a computer system or software application for which no patch or fix has been released by the vendor. The term “zero-day” refers to the fact that the vulnerability is unknown to the software developer or vendor, leaving zero days for them to prepare and release a security patch. Further, typically the network traffic uses encrypted packets, so the network firewall must rely on heuristics to detect that a threat or vulnerability has occurred.

### SUMMARY

Embodiments are directed to a firewall for a virtual machine (“VM”) application. Embodiments initiate event monitoring of the VM application. Embodiments receive an event and compare the event to a plurality of events stored in a baseline profile of the VM application. When the event differs from any of the plurality of events, embodiments automatically generate an alert and/or perform an action corresponding to the VM application.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes a virtual machine (“VM”) firewall system in accordance to embodiments.

FIG. 2 is a block diagram of a computer server/system in accordance with an embodiment of the present invention that can be used to implement any of the functionality disclosed herein.

FIG. 3 is a flow/block diagram of the functionality of the VM firewall module of FIG. 2 when providing a firewall for VM applications in accordance to embodiments.

FIGS. 4-7 illustrate an example cloud infrastructure that can incorporate a network cloud that can include the VM firewall system of FIG. 1 in accordance to embodiments.

### DETAILED DESCRIPTION

One embodiment is a virtual machine firewall for monitoring applications executing on virtual machines, such as a Java Virtual Machine (“JVM”). The firewall receives events for the monitored application from a flight recorder or other event monitoring tool, and determines if each event represents an anomaly or threat. Embodiments work directly with the running applications and can inspect the execution path.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

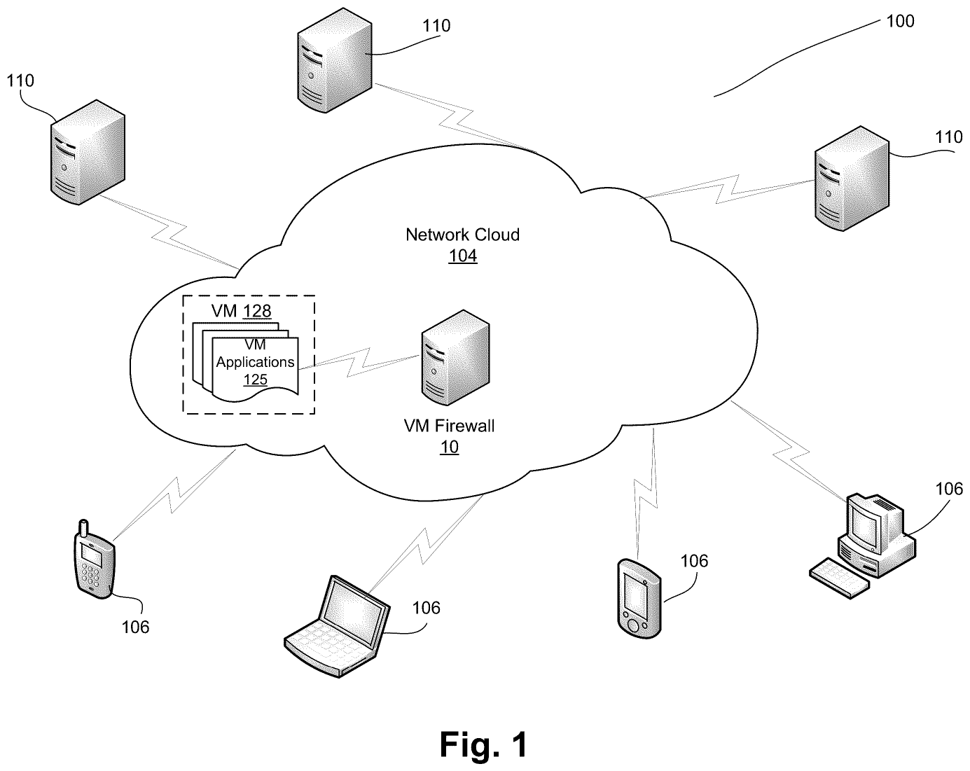

FIG. 1 illustrates an example of a system 100 that includes a virtual machine (“VM”) firewall system 10 in accordance to embodiments. VM firewall system 10 may be implemented within a computing environment that includes a communication network/cloud 104. Network 104 may be a private network that can communicate with a public network (e.g., the Internet) to access additional services 110 provided by a cloud services provider (i.e., a cloud infrastructure). Examples of communication networks include a mobile network, a wireless network, a cellular network, a local area network (“LAN”), a wide area network (“WAN”), other wireless communication networks, or combinations of these and other networks. VM firewall system 10 may be administered by a service provider, such as via the Oracle Cloud Infrastructure (“OCI”) from Oracle Corp.

Tenants of the cloud services provider can be organizations or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of VM firewall system 10 of providing a firewall for VM applications executing within a VM. As disclosed herein, a “client” (also disclosed as a “client system” or a “client device”) may be a device or an application executing on a device. System 100 includes a number of different types of client devices 106 that each is able to communicate with network 104.

Cloud 104 includes a plurality of VM applications 125 that are each executing on one or more VMs 128. In embodiments, VM applications 125 are Java applications that are executing on a Java VM (“JVM”). A JVM provides a runtime environment for driving Java applications or code. JVM is an abstract machine that converts the Java bytecode into a machine language. JVMs serve two primary purposes: the first is to provide a means for a Java program to run in any environment. The second is to maintain and optimize program memory.

JVM 128 includes a Java Flight Recorder (“JFR”), which is a tool for collecting diagnostic and profiling data about a running Java application. It is integrated into the JVM and causes almost no performance overhead, so it can be used even in heavily loaded production environments. JFR collects data, such as events, about the JVM as well as the Java application running on it. For non-Java implementations, any event monitoring or event capture tool can be used.

VM 125 can be implemented by a JVM, or by any VM machine, like JVM, that functions as an interpretive layer for interpreted languages such as Java, Ruby, Python, Kotlin, Scala, etc. These interpretive languages are first compiled into “bytecode”. The bytecode then runs on a language virtual machine that is architecture specific and is responsible for mapping the bytecode to machine code at runtime (i.e., this translation happens dynamically when the bytecode is executed). Interpreted languages are generally less performant compared to compiled languages due to the overhead of the dynamic translation from bytecode to machine code in the intermediary language virtual machine layer. As disclosed, JVM includes the JFR to capture events. Other interpreted languages, such as Ruby and Python, also have flight recorder capabilities that can monitor and capture events on the execution of the applications.

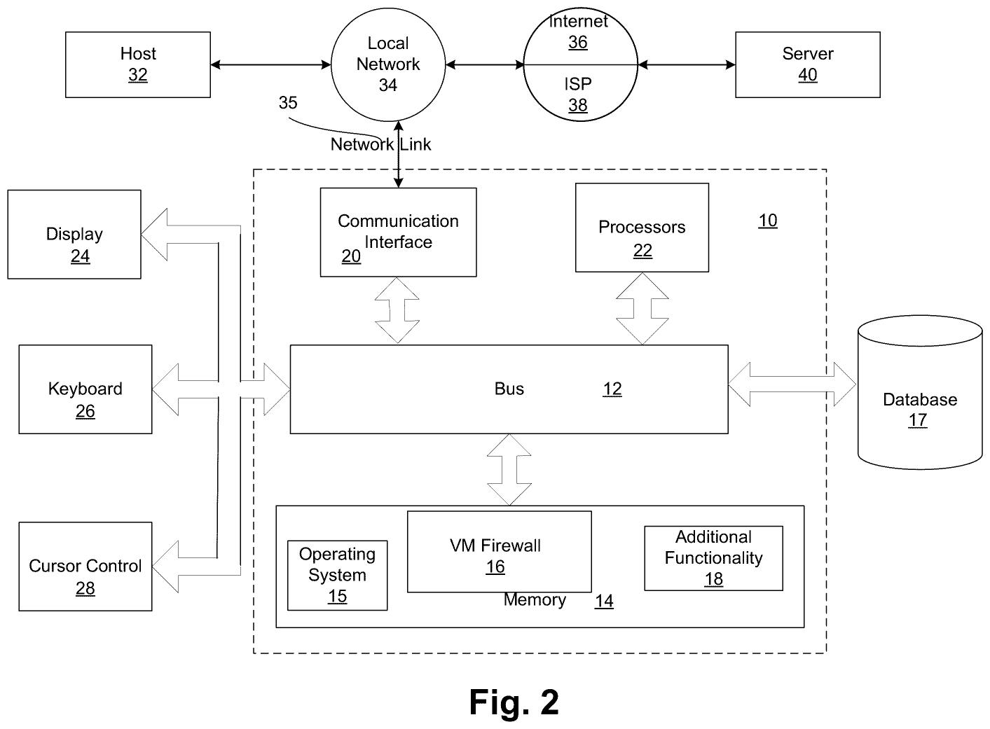

FIG. 2 is a block diagram of a computer server/system 10 in accordance with an embodiment of the present invention that can be used to implement any of the functionality disclosed herein. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a VM firewall module 16 that provides a firewall for VM applications, and all other functionality disclosed herein. System 10 can be part of a larger system. Therefore, system 10 can include one or more additional functional modules 18 to include the additional functionality that needs a firewall, such as VM applications (e.g., VM applications 125) and the VM (e.g., JVM 128). A file storage device or database 17 is coupled to bus 12 to provide centralized storage for modules 16 and 18, including baseline data for each VM application to be monitored in the form of an application profile. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

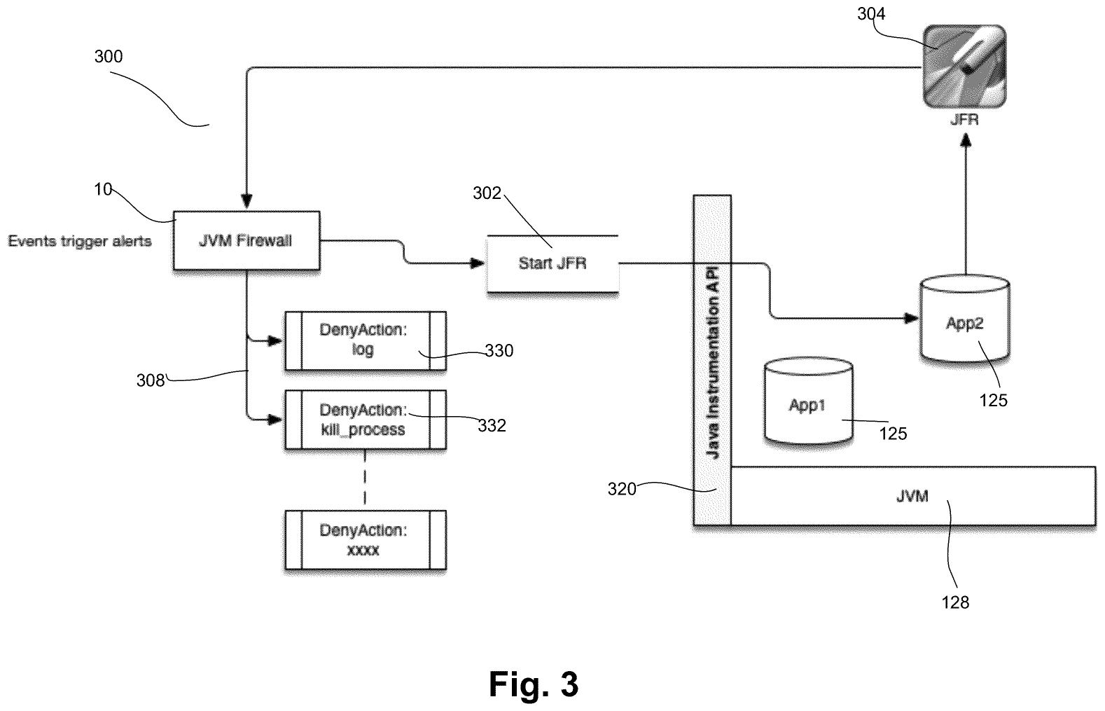

FIG. 3 is a flow/block diagram of the functionality 300 of VM firewall module 16 of FIG. 2 when providing a firewall for VM applications in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. The embodiment of FIG. 3 is implemented using Java and a JVM, but can also be implemented using other known interpreted languages.

As shown in FIG. 3, one or more Java applications 125 are executed by or within a JVM 128. JVM 128 includes a Java Instrumentation API 320. In general, Java Instrumentation API 320 is used for Java application performance instrumentation, but in embodiments is also used for event monitoring. Before the functionality of FIG. 3 is implemented, the baseline behavior of each application 125, while not under “attack”, is generated (e.g., 30 days of activity) and stored as an application profile.

A JFR 304 may be a separate module or integrated with JVM 128, and collects data regarding JVM 128 and Java applications 125. Part of the data includes events. Events occur in the JVM or the Java application at a specific point in time. Each event has a name, a time stamp, and an optional payload. The payload is the data associated with an event, for example, the CPU usage, the Java heap size before and after the event, the thread ID of the lock holder, and so on. Using the information available in events, the runtime details for the JVM and the Java application can be reconstructed. In other embodiments, other devices that can monitor for events for VM applications can be used.

In embodiments that are implemented using known versions of JFR for the monitoring of events, the Events in JFR are modified so that in I/O, JFR Events outputs the file path. Further, the JFR is modified so that Class Load Events pass back information on parameters and calling threadID and the process which caused the Class Load event. Further the JFR is modified to provide temporary listing of events. When a specific event is deemed to be “safe”, the JFR ignores reporting of that event.

Further, known JFRs currently collects logs for each JVM it runs on, but in a containerized environment many containers are running and the total data captured can be large. To reduce the dataset transmitted, in embodiments, a JFR component running in the Kubernetes can perform lightweight filtering of logs, such that identical logs are ignored, and only unique data is passed back for analysis. However, in embodiments, because identical/repeated log entries may indicate an attack, this type of filtering may be not used.

At 302, the JFR 304 event monitoring is started, providing monitoring JVM 128, and all corresponding Java applications 125. In response, events for Java applications 125 are captured by JFR 304.

The monitored VM applications 125 can be located on the same cloud, on different clouds, including clouds from different vendors (e.g., AWS, Azure, etc.) or on-premise, as long as the VM applications are executing within a VM container. In embodiments, a event collection service, such as Java Managed Service (“JMS”), captures monitored logs from JFR 304 (or other type of monitoring function) for all VM applications regardless of where they are executing. JMS is a native OCI service that monitors Java deployments on OCI instances and instances running in customer data centers.

The events are provided to JVM firewall 10, which in response triggers alerts and corresponding actions 308 if the events differ (i.e., anomalies) from known good events (possibly generated during the baseline monitoring, or manually configured) based on the specific events and event attributes. For example, the alert at 330 can be “DenyAction” with the action being log, or at 332 “DenyAction” with the action being kill the process that generated the event.

In general, embodiments operate in real-time (or near real-time, depending on the latency between the JVM Firewall and JFR platform, as well as sampling and/or filtering of JFR events), catching potentially malicious application behaviors as they happen. Behavior patterns can be defined via threshold-based policies or scenario-based policies, with each scenario made up of one or more rules. The identification of potentially malicious behavior is based on observed deviations from a baseline pattern for each of the applications.

As disclosed, the normal, safe, trusted and expected behavior of each monitored VM application 125 is stored in an application profile. The application profile describes what is the expected (and potentially forbidden) behavior for a given application. Application profiles may be generated manually or via automated learning. Automated learning allows JVM firewall 10 to profile the application itself, creating a baseline of “good” behavior. In embodiments, the automated profile generation will ideally get the application profile ˜80% complete, with the developer(s) confirming and adjusting the profile to complete the remaining 20% (this is an approximation, as each application and application learning exercise might be different). In other embodiments, the profile generation will be completely automated (i.e., no human intervention). Thorough application code testing will allow for exposure to most or all of the application code. Profiling an application during the testing phase of the development lifecycle is an ideal location to profile an application.

Application profiles are intended to be populated by the application developer(s). End-users of the application would reference the application profile and give specific actions that should be taken (specific to their environment) for when an application takes action outside of what has been defined.

The generated baseline application profile contains information about the typical behavior and performance of the Java application. It includes data on CPU usage, memory usage, garbage collection, thread activity, and other relevant metrics. In addition to this, the profile also contains information about the various JFR events (class loads, method loads, exceptions, executed SQL queries, etc.) that were captured, along with their timestamp and frequency.

On reviewing the baseline profile, users can set thresholds or rules for certain events and event patterns and configure the channels on which they can be notified of breaches. Users can also configure catch-all notifications for any new anomaly that may occur outside of the set thresholds and rules. In embodiments where cloud 104 is implemented by OCI, the supported notification mechanisms will include logging into OCI Logging, notifying via OCI Notification service, notifying via email, and notifying via monitoring service.

In addition to being notified, customers can optionally configure actions (e.g., actions 330, 332) to be carried out when a particular rule/malicious pattern is detected. Examples of some actions in embodiments include isolating a VM, stopping a VM, making an Hypertext Transfer Protocol (“HTTP”) call, loading a class/method, running a function, or streaming to OCI streaming services for high-volume apps.

As disclosed, the real-time monitoring of the events and comparing to baseline activity can result in near real-time identifying and actions in response to malicious attacks. For example, with “Log4Shell-type” attacks, an attacker exploiting the Log4J vulnerability may send a large number of log messages with specific payloads or may attempt to execute certain commands or load specific classes. This behavior can be detected by monitoring for, for example, the following JFR events or JVM events (embodiments are not limited to the following events, as a different selection of JFR and JVM events may be implemented):

1) jdk.ThreadMonitorContention Event: Indicates contention for a Java monitor object by multiple threads, which could indicate an attack where multiple threads are trying to access a Log4J logger simultaneously.

2) jdk.ClassLoad Event with an unexpected/new class: This event indicates when a Java class is loaded, which could potentially indicate an attack where an attacker is trying to load a malicious class into the application.

3) jdk.ThreadSleep Event: This event indicates when a Java thread is sleeping, which could potentially indicate an attack where an attacker is trying to avoid detection or delay an attack.

4) jdk.ThreadPark Event: This event indicates when a Java thread is parked, which could potentially indicate an attack where an attacker is trying to avoid detection or delay an attack.

5) jdk.ThreadStart Event: This event indicates when a Java thread is started, which could potentially indicate an attack where an attacker is spawning new threads to carry out the attack.

For structured query language (“SQL”) injection attacks, the JFR can capture detailed information about SQL queries executed by the application. SQL injection is a web security vulnerability that allows an attacker to interfere with the queries that an application makes to its database. It generally allows an attacker to view data that they are not normally able to retrieve. This might include data belonging to other users or any other data that the application itself is able to access. In many cases, an attacker can modify or delete this data, causing persistent changes to the application's content or behavior. In some situations, an attacker can escalate a SQL injection attack to compromise the underlying server or other back-end infrastructure or perform a denial-of-service attack.

To detect a SQL injection attack by JVM firewall 10 in embodiments, using JFR, certain patterns or anomalies in the SQL query events are detected. For example, SQL queries may contain unusual or suspicious keywords, such as “DROP,” “DELETE,” or “TRUNCATE” may indicate an attempt to perform unauthorized actions on the database. In addition, the JFR can be used to monitor the frequency and duration of SQL queries. Unusually high query rates or long query durations may indicate an SQL injection attack or other performance issues. In embodiments, JFR 304 can provide the following relevant example events to JVM firewall 10 that can be used to detect a SQL injection attack (embodiments are not limited to the following events, as a different selection of events may be implemented):

1) jdk.SQL—This event captures information about SQL statements executed by the application, including the SQL text, the time the statement was executed, and the duration of the statement. This event can be used to detect suspicious or unusual SQL queries.

2) jdk.ClassLoading—This event captures information about the loading and unloading of classes by the application. This event can be used to detect the loading of classes related to SQL injection attacks, such as JDBC drivers that may be used to execute malicious SQL queries.

3) jdk.Exception—This event captures information about exceptions thrown by the application. This event can be used to detect exceptions related to SQL injection attacks, such as SQLExceptions that may indicate an attempt to execute malicious SQL queries.

4) jdk.ThreadDump—This event captures a stack trace for each thread in the application at a specific point in time. This event can be used to identify threads that are executing suspicious or unusual SQL queries, which may indicate an SQL injection attack.

5) jdk.GCHeapSummary—This event provides information about the state of the garbage collector heap, including the number and size of objects. This event can be used to detect excessive memory usage caused by an SQL injection attack.

Data exfiltration is a malicious process where cybercriminals (e.g., external actors) or insiders (e.g., employees, contractors, and third-party suppliers) accidentally or deliberately steal or move data from inside to outside a company's perimeter without authorization. Data exfiltration attacks in Java applications can be detected by JVM firewall 10 in embodiments via JFR or JVM events by monitoring network I/O activity and identifying suspicious outbound network traffic. One way to do this is by monitoring the ‘jdk.SocketWrite’ event in JFR, which records all socket write operations, including the destination host and port. This can be used to identify any unusual outbound network traffic, especially if it is going to a suspicious or unknown destination. Additionally, monitoring the JNDI and LDAP events, such as ‘jdk.jndi’, ‘jdk.Idap’, and ‘javax.naming.*’, can also be useful in detecting data exfiltration attacks that use these protocols to extract sensitive data. Overall, the key to detecting data exfiltration attacks is to have a clear understanding of normal traffic patterns and behaviors in a Java application.

Code injection, or remote code execution (“RCE”) attacks, can be detected by JVM firewall 10 in embodiments. In an RCE attack, an attacker exploits a vulnerability or flaw in a software application or system that allows them to execute code remotely on the target's machine. This can allow the attacker to take control of the system, steal sensitive data, or launch further attacks on other systems or networks. Typically, an RCE attack involves suspicious use of native method calls. There are several native method calls that an attacker may use in an RCE attack. Any new and significant usage of these native methods could indicate an RCE attack, and JVM events are available for tracing these native method calls. Some of the most common native methods are as follows:

1) Runtime.exec( )—This method is used to execute a system command. An attacker may use it to execute arbitrary commands on the target system.

2) ClassLoader.defineClass( )—This method is used to define a new class at runtime. An attacker may use it to load and execute malicious code or new/unexpected classes.

3) ProcessBuilder.start( )—This method is similar to Runtime.exec ( ) and is used to start a new process. An attacker may use it to execute arbitrary commands on the target system.

4) Reflection APIs—The Java reflection APIs allow developers to inspect and modify the behavior of Java classes at runtime. An attacker may use reflection to bypass security checks and execute arbitrary code.

5) JNI (Java Native Interface)—JNI allows Java code to call native code written in other languages, such as C or C++. An attacker may use JNI to execute native code on the target system.

Java Naming and Directory Interface (“JNDI”) attacks can be detected by JVM firewall 10 in embodiments. JNDI injection attacks are a type of attack that exploits a vulnerability in Java applications that use JNDI to perform directory lookups. JFR events, such as the jdk.Security event and jdk.ObjectMonitorEnter event can be used to detect a JNDI attack. The jdk.Security event generates information about security-related events, including security manager checks, access control checks, and permission checks. By analyzing the information generated by this event, it is possible to detect suspicious JNDI-related activity, such as attempts to look up or modify JNDI resources without proper authorization or authentication, and in high volumes. If simultaneously high memory usage and exception events are also observed, they can collectively indicate a JNDI attack.

Further, the jdk.ObjectMonitorEnter event generates information that can be analyzed to detect attempts to access JNDI resources while holding monitor locks or attempts to modify JNDI resources while other threads are accessing them.

Embodiments can further detect dynamic code loading, which is a mechanism by which a computer program can, at run time, load a library (or other binary) into memory, retrieve the addresses of functions and variables contained in the library, execute those functions or access those variables, and unload the library from memory. It allows a program to start up in the absence of these libraries, discover available libraries, and potentially gain additional functionality. Dynamic code loading in embodiments can be detected by detecting similar events as with the remote code execution detecting disclosed above.

Embodiments can further detect a zero-day threat or zero-day vulnerability, which is an unknown vulnerability in the computer or mobile device's software or hardware. The term is derived from the age of the exploit, which takes place before or on the first (or “zeroth”) day of a security vendor's awareness of the exploit or bug. Embodiments, by enforcing only known (i.e., good, safe) application behaviors, can prevent unknown/unexpected behaviors.

Embodiments can further detect a Lightweight Directory Access Protocol (“LDAP”) injection. LDAP is a common software protocol designed to enable anyone on a network to find resources such as other individuals, files, and devices. Directory services such as LDAP are useful for intranets. It can also be used to store usernames and passwords as part of a single sign-on (“SSO”) system. LDAP injection is a vulnerability in which queries are constructed from untrusted input without prior validation or sanitization. LDAP uses queries constructed from predicates that involve the use of special characters (e.g., brackets, asterisks, ampersands, or quotes). Metacharacters such as these control the meaning of the query, thereby affecting the type and number of objects retrieved from the underlying directory. If an attacker can submit input containing these control characters, they can alter the query and change the intended behavior. Embodiments can detect, for example, JNDI and LDAP events, such as ‘jdk.jndi’, ‘jdk.Idap’, in order to detect an LDAP detection.

### Example Cloud Infrastructure

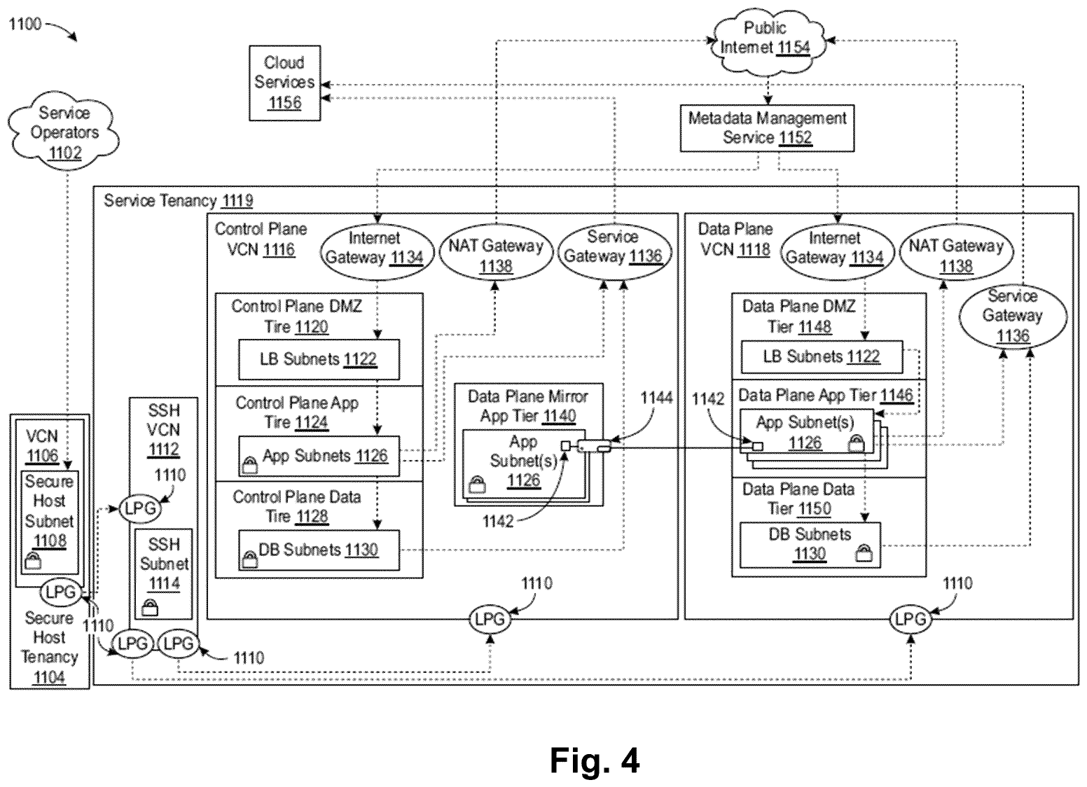

FIGS. 4-7 illustrate an example cloud infrastructure that can incorporate network cloud 104 that can include VM firewall system 10 of FIG. 1 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS” s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 4 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users′, or other customers′, resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

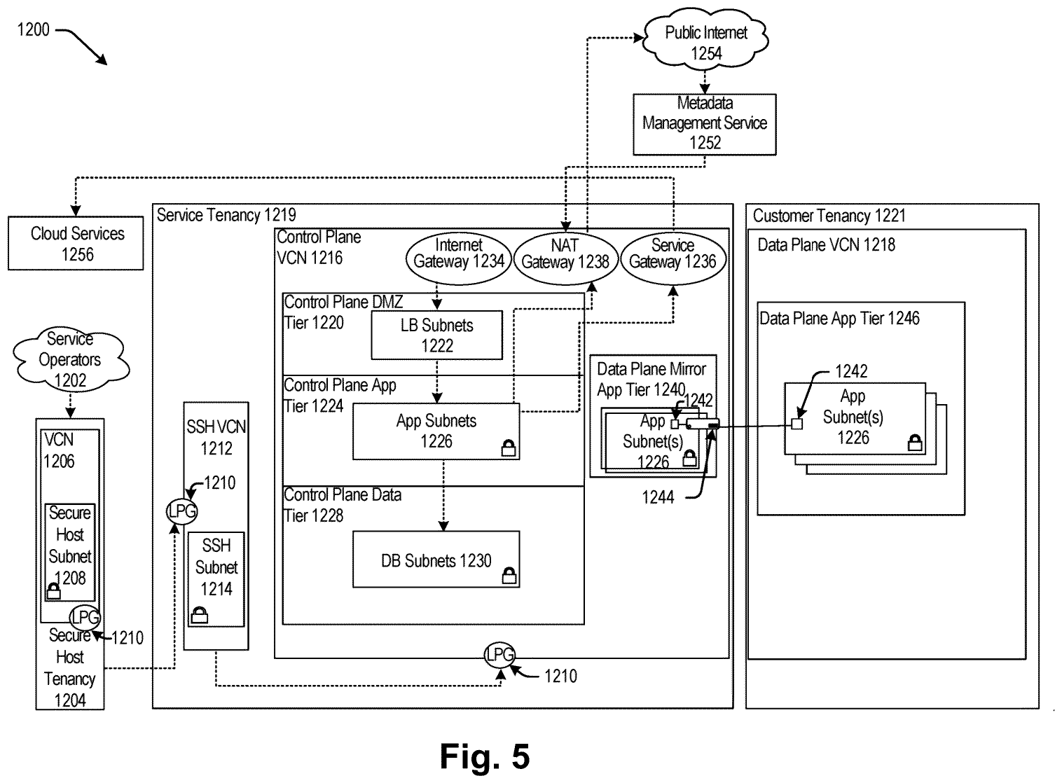

FIG. 5 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

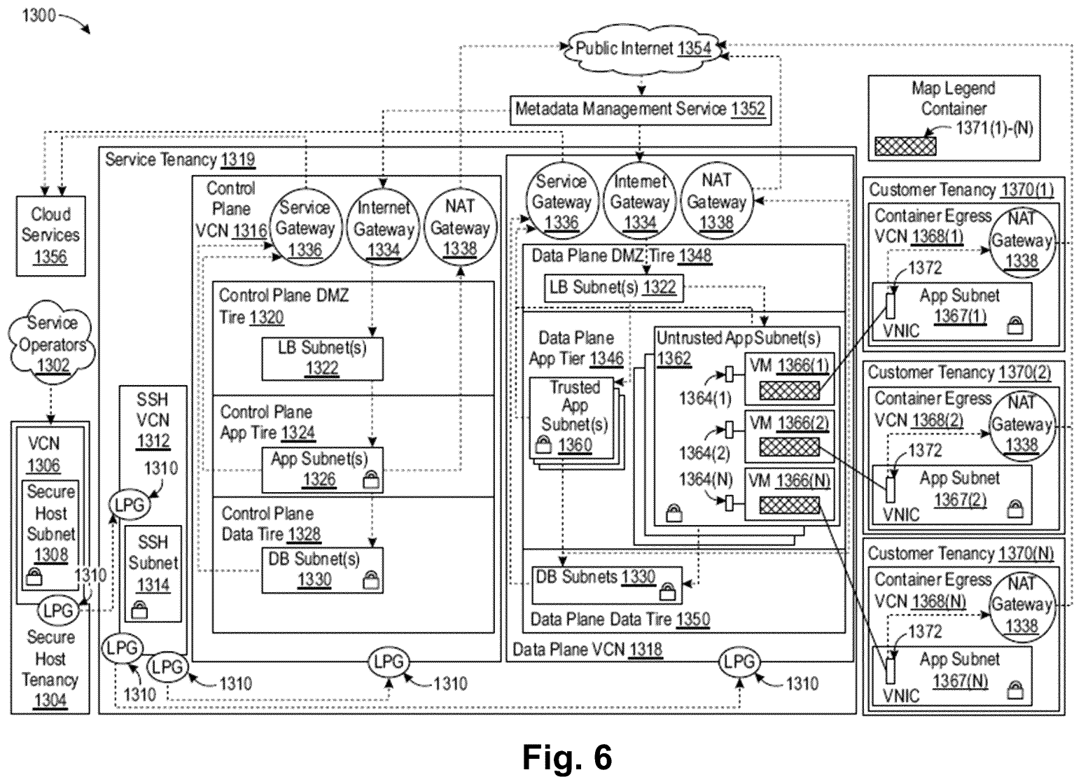

FIG. 6 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

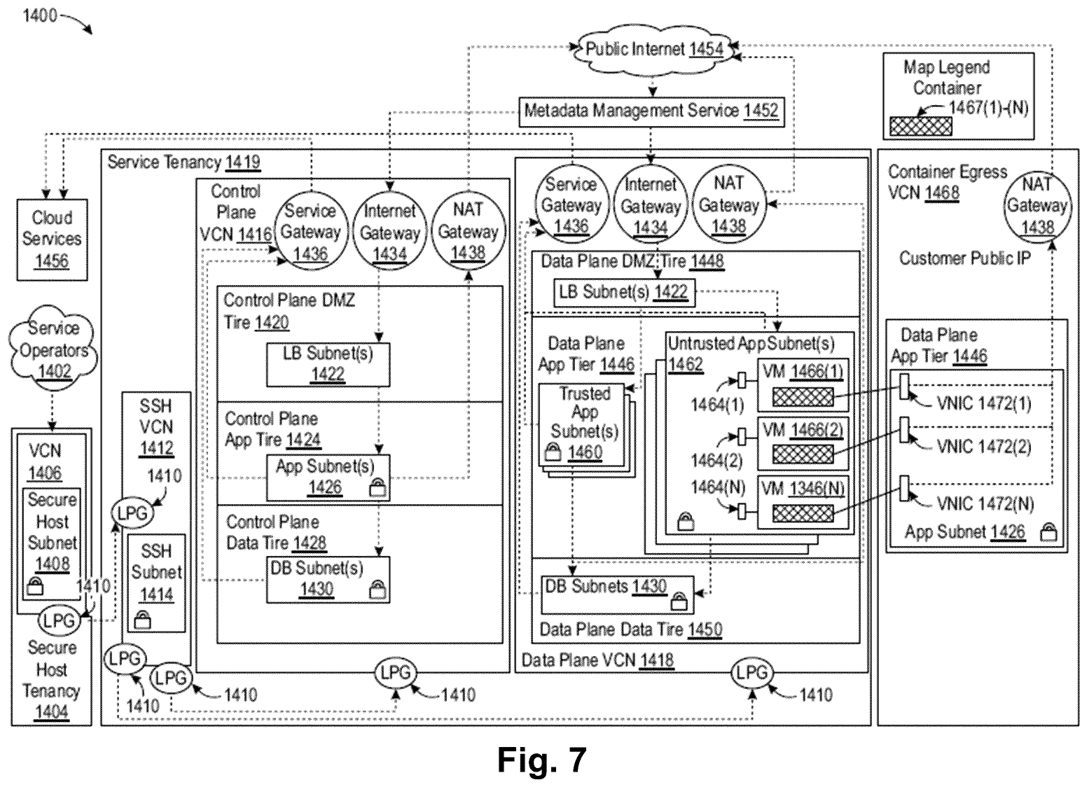

FIG. 7 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 11) and a network address translation (NAT) gateway 1438 (e.g. the NAT gateway 1138 of FIG. 11). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 7 may be considered an exception to the pattern illustrated by the architecture of block diagram 1300 of FIG. 6 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, with VM firewall 10, in accordance to embodiments, customers can proactively detect and mitigate malicious activity. Customers can generate a baseline application profile for expected behavior (e.g., loaded classes, methods called, and the associated Java Flight Recorder events). VM firewall 10 will then monitor the application's Java runtime for unexpected behavior such as: 1) a class/method being executed that is not expected from the profiling; 2) injected code (SQL, code, command/script/connection string injections); and 3) a rarely taken code path being exercised suddenly or frequently. On detecting any such behavior, embodiments will immediately notify the customers of the deviation and/or carry out user-defined actions, if any. The notification will include details such as when and where in the code the deviation occurred, its frequency, etc. This information will enable customers to verify if the behavior indicates malicious activity. If so, they can take action to block/isolate the bad actor. If the behavior is not a malicious activity but a benign edge case, customers can add the tagged event to the desired application profile to prevent future alerts.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of operating a firewall for a virtual machine (VM) application, the method comprising:
initiating event monitoring of the VM application;
receiving an event;
comparing the event to a plurality of events stored in a baseline profile of the VM application; and
when the event differs from any of the plurality of events, automatically generating an alert and/or performing an action corresponding to the VM application.

2. The method of claim 1, wherein the VM application is executing within a VM.

3. The method of claim 2, wherein the VM application is a Java application, and the VM is a Java VM.

4. The method of claim 3, wherein the event monitoring is implemented by a Java Flight Recorder.

5. The method of claim 2, wherein the action comprises at least one of: isolating the VM, stopping the VM, making an Hypertext Transfer Protocol (HTTP) call, loading a class/method or running a function.

6. The method of claim 1, wherein the firewall is executed by a first cloud based infrastructure and the VM application is executed by a second cloud based infrastructure that is different then the first cloud based infrastructure.

7. The method of claim 1, wherein the firewall is executed by a cloud based infrastructure and the VM application is executed on-premise.

8. The method of claim 1, wherein the baseline profile comprises one or more of central processing unit (CPU) usage, memory usage, garbage collection or thread activity.

9. A computer readable medium having instructions stored thereon that, when executed by one or more processors, cause the processors to operate a firewall for a virtual machine (VM) application, the operating comprising:
initiating event monitoring of the VM application;
receiving an event;
comparing the event to a plurality of events stored in a baseline profile of the VM application; and
when the event differs from any of the plurality of events, automatically generating an alert and/or performing an action corresponding to the VM application.

10. The computer readable medium of claim 9, wherein the VM application is executing within a VM.

11. The computer readable medium of claim 10, wherein the VM application is a Java application, and the VM is a Java VM.

12. The computer readable medium of claim 11, wherein the event monitoring is implemented by a Java Flight Recorder.

13. The computer readable medium of claim 10, wherein the action comprises at least one of: isolating the VM, stopping the VM, making an Hypertext Transfer Protocol (HTTP) call, loading a class/method or running a function.

14. The computer readable medium of claim 9, wherein the firewall is executed by a first cloud based infrastructure and the VM application is executed by a second cloud based infrastructure that is different then the first cloud based infrastructure.

15. The computer readable medium of claim 9, wherein the firewall is executed by a cloud based infrastructure and the VM application is executed on-premise.

16. The computer readable medium of claim 10, wherein the baseline profile comprises one or more of central processing unit (CPU) usage, memory usage, garbage collection or thread activity.

17. A cloud based firewall system for a virtual machine (VM) application, the system comprising:
one or more processors executing instructions and configured to:
initiate event monitoring of the VM application;
receive an event;
compare the event to a plurality of events stored in a baseline profile of the VM application; and
when the event differs from any of the plurality of events, automatically generate an alert and/or perform an action corresponding to the VM application.

18. The system of claim 17, wherein the VM application is executing within a VM.

19. The system of claim 18, wherein the VM application is a Java application, and the VM is a Java VM.

20. The system of claim 19, wherein the event monitoring is implemented by a Java Flight Recorder.
